(19) United States
(12) Patent Application Publication
(10) Pub. No.: US 2006/0288821 A1
(43) Pub. Date: Dec. 28, 2006

(54) Ratchet wrench apparatus

(76) Inventor: Don Girard, Rancho Cordova, CA (US)

Correspondence Address: THOMAS R. LAMPE;BIELEN, LAMPE & THOEMING, 1390 WILLOW PASS ROAD, SUITE 1020, CONCORD, CA, 94520, US

(21) Appl. No.: 11/159,468

(22) Filed: Jun. 23, 2005

(51) Int. Cl. B25B 13/46; B25B 13/00

(52) U.S. Cl. 81/58.1

(57) ABSTRACT

A manually engageable extension member is connected to a socket projection of a ratchet wrench and is utilized to facilitate threading between a nut and bolt or stud.

### TECHNICAL FIELD

This invention relates to a ratchet wrench apparatus which incorporates a ratchet wrench of conventional construction in combination with structure facilitating threading between a nut and bolt or stud.

### BACKGROUND OF THE INVENTION

Ratchet wrenches are well known tools employed with a socket to tighten nuts and bolts or studs. Usually the nut is manually placed on the bolt or stud and spun by use of fingers until the nut contacts the workpiece. Then the ratchet wrench is applied to tighten it. On occasion the nut drag on the bolt is too great to allow one to tighten the nuts into position by direct finger contact. In those instances the ratchet has to be applied to spin the nut down slowly, an annoying, time consuming and tedious process. Sometimes the drag is such as to be too great for direct finger threading but not enough to overcome the back drag of the ratchet wrench. Then an open end or box wrench must be used, sloth-like, to run the nut down on the threaded bolt or stud.

As will be described in greater detail below, the apparatus of the present invention is employed to overcome the above-identified problems as well as to add speed and convenience to the process. Preliminary threading of nuts can be accomplished through utilization of the ratchet wrench but without having to move the ratchet wrench handle. This is accomplished without direct contact between one's fingers and the nut.

U.S. Pat. No. 5,095,781 discloses a ratchet spinner comprising a centrally apertured disc with a serrated peripheral edge. An integral segmented collar surrounds the central disc aperture protrudes axially therefrom. The segmented collar defines a plurality of flat sided flanges arranged tangentially with respect to the circumference of the central aperture.

U.S. Pat. No. 5,152,196 discloses a ratchet wrench having auxiliary ratcheting mechanism having a knob-like configuration. The auxiliary ratchet has a lower ratcheting resistence than the primary mechanism but back and forth movement of a nut can still occur.

U.S. Pat. No. 6,681,660 discloses a variable speed ratchet wrench comprising a main handle portion with an opening for receiving a planetary gear mechanism. An attached secondary handle allows the planetary gears to revolve relative to the sun gear in a non-locked position and prevents the planetary gears from revolving around the sun gear when locked in a locked position, thereby providing a geared speed increase in the driven speed in the output shaft.

U.S. Pat. No. 6,138,531 discloses a hand ratchet wrench. U.S. Design Pat. Nos. 340,628 and 421,624 illustrate ornamental designs for ratchet wrenches.

### DISCLOSURE OF INVENTION

The present invention has particular application to ratchet wrenches which employ a double-sided wrench rotor rotatably mounted in the wrench head. The illustrated embodiments of the invention are incorporated with such arrangements wherein projections extend from the opposed sides of the double-sided wrench rotor. The prior art arrangements of record are not suitable for use with this type of ratchet wrench. Furthermore, the invention may be quickly and readily employed to perform the task of nut tightening. The invention is characterized by its relative simplicity, ease of use and low cost. Threading or tightening of nuts with high drag, low drag and drag in between can be readily accomplished.

The combination of the invention includes a ratchet wrench having a wrench head, a wrench handle extending from the ratchet head, and a double-sided wrench rotor rotatably mounted in the wrench head. A pair of projections extend from opposed sides of the double-sided wrench rotor and are rotatable therewith, at least one of the projections being selectively releasably engageable with a socket in the normal manner.

A manually engageable extension member is connected to the other of the projections and extends outwardly therefrom for rotating the wrench rotor along with any socket attached to the projection not connected to the manually engageable extension member.

Other features, advantages and objects of the present invention will become apparent with reference to the following description and accompanying drawings.

### BRIEF DESCRIPTION OF DRAWINGS

FIG. 1 is a perspective view of a preferred embodiment of manually engageable extension member constructed in accordance with the teachings of the present invention;

FIG. 2 illustrates the manually engageable extension member connected to a ratchet wrench;

FIG. 3 is an enlarged, elevational view showing the manually engageable extension member in cross-section as taken along line 3-3 in FIG. 2 prior to connection thereof to the ratchet wrench;

FIG. 4 is a view similar to FIG. 1 of an alternative embodiment of the manually engageable extension member;

FIG. 5 is a perspective view showing the FIG. 4 embodiment of the extension member in place on a ratchet wrench;

FIG. 6 is an enlarged, cross-sectional view of the alternative embodiment of the manually engageable extension member;

FIG. 7 is a perspective view of a third embodiment of manually engageable extension member;

FIG. 8 shows the third embodiment in place on a ratchet wrench;

FIG. 9 is a cross-sectional view taken along line 9-9 of FIG. 8 of the third embodiment;

FIG. 10 illustrates use of the first embodiment of the invention, the manually engageable extension member being manually rotated as shown by a double-headed arrow;

FIG. 11 is a view similar to FIG. 10 showing the third embodiment of manually engageable extension member being turned;

FIG. 12 is a perspective view showing the third embodiment of the manually engageable extension member being turned;

FIGS. 13 and 14 are views similar to FIGS. 5 and 6, but showing a fourth embodiment of the invention; and

FIGS. 15 and 16 are cross-sectional views respectively of fifth and sixth invention embodiments.

### MODES FOR CARRYING OUT THE INVENTION

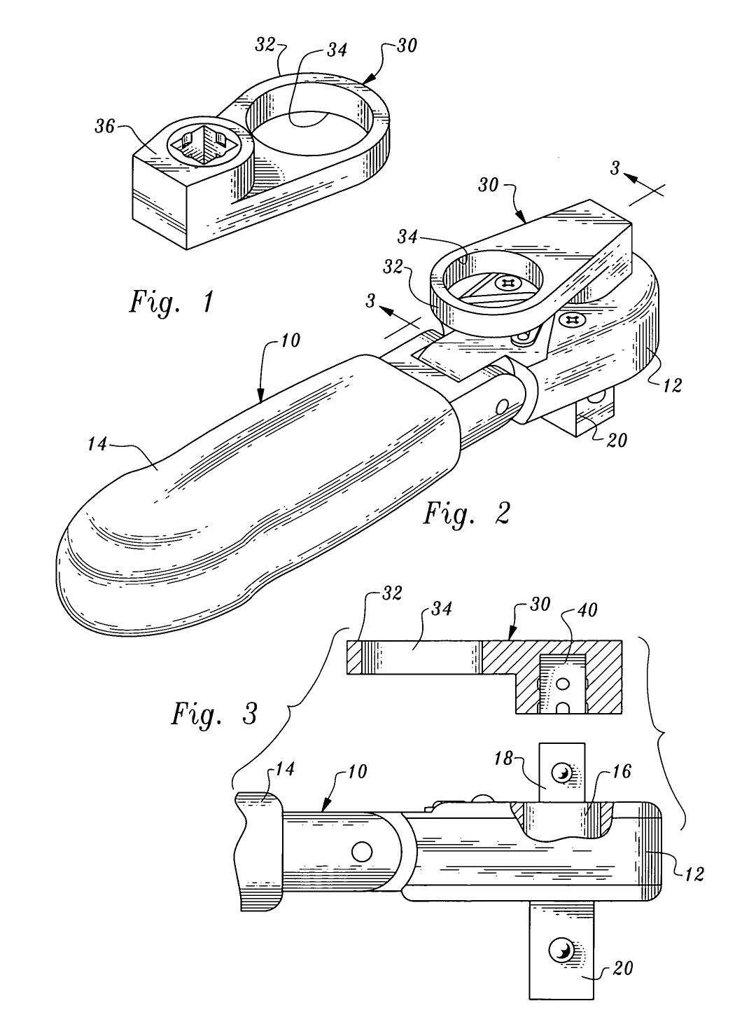

Referring now to FIGS. 1-3 and 11 a preferred form of the invention is illustrated. A ratchet wrench of conventional construction is designated by reference numeral 10. The ratchet wrench has a wrench head 12, a wrench handle 14 extending from the ratchet head and a double-sided wrench rotor or spinning element 16 rotatably mounted in the wrench head, a pair of projections 18, 20 extending from opposed sides of the double-sided wrench rotor and rotatable therewith.

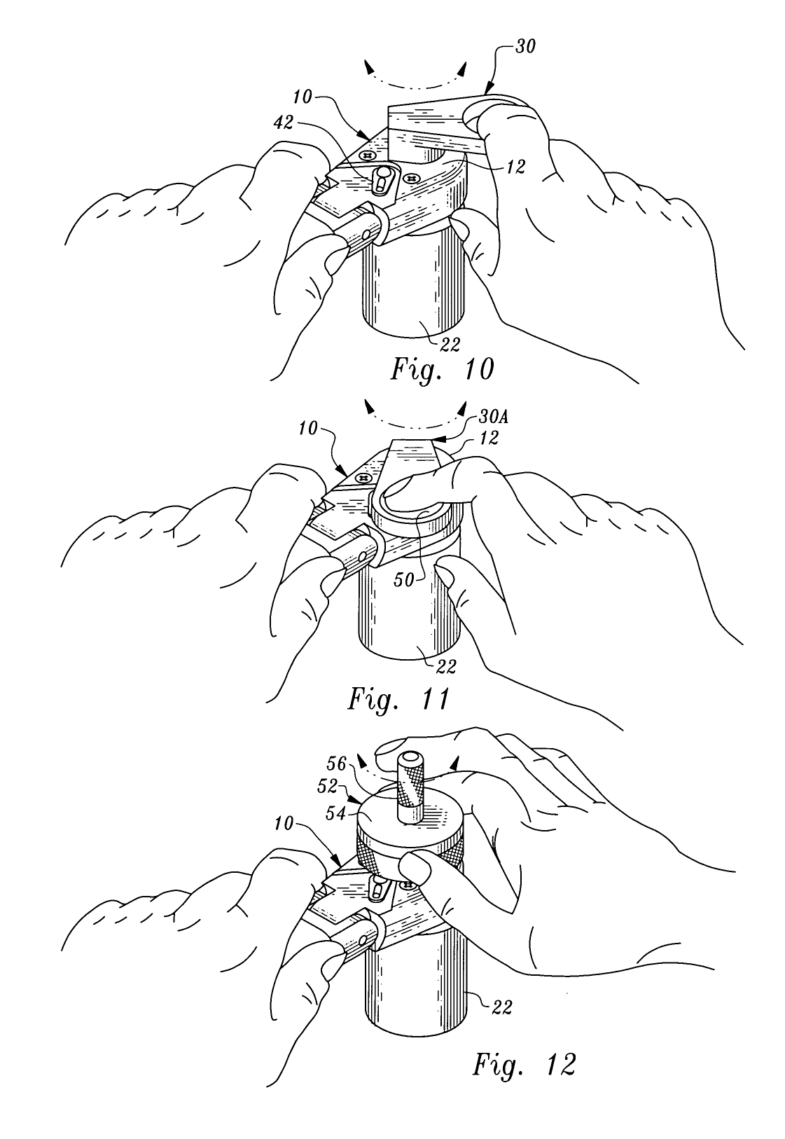

As is known in the art, the projections are of different sizes to accommodate different sized sockets. FIGS. 10 and 11 show a socket 22 connected to projection 20. The projections are affixed to the wrench rotor and rotatable therewith.

Reference numeral 30 designates a manually engageable extension member constructed in accordance with the teachings of the present invention. Member 30 is an elongated member having a distal end 32 defining a hole 34 for receiving a user's finger. More particularly, the hole 34 is in the nature of an opening extending through the distal end. FIG. 10 shows member 30 being rotated by a person's finger extending through the hole.

Manually engageable extension member 30 is of rigid, unitary construction and includes a base portion 36. An elongated arm 38 is integrally attached to the base portion at a location spaced from the wrench head.

The manually engageable extension member extends outwardly beyond the wrench rotor to provide a mechanical advantage when utilizing the manually engageable extension member to turn the wrench rotor.

In the illustrated embodiment, manually engageable extension member 30 is releasably connected to projection 18 for rotating the wrench rotor and a socket receiving projection 20. The base portion 36 defines a recess 40 receiving projection 18. The same indent/detent arrangement employed to attach sockets to projections of a ratchet wrench is employed in the manually engageable extension member to releasably connect the manually engageable extension member and the projection 18. The interior shape of recess 40 corresponds to the shape of projection 18 and relative rotational movement between the projection and manually engageable extension member is prevented when the projection 18 is received in the recess.

FIG. 10 shows the manually engageable extension member releasably connected to the wrench and utilized to turn the projections, attached rotor and socket 22 merely by inserting one's finger in the hole and applying a rotational force. This may be done in either the clockwise or counter-clockwise direction as indicated by the double-headed arrow depending upon the position of the ratchet wrench control lever 42.

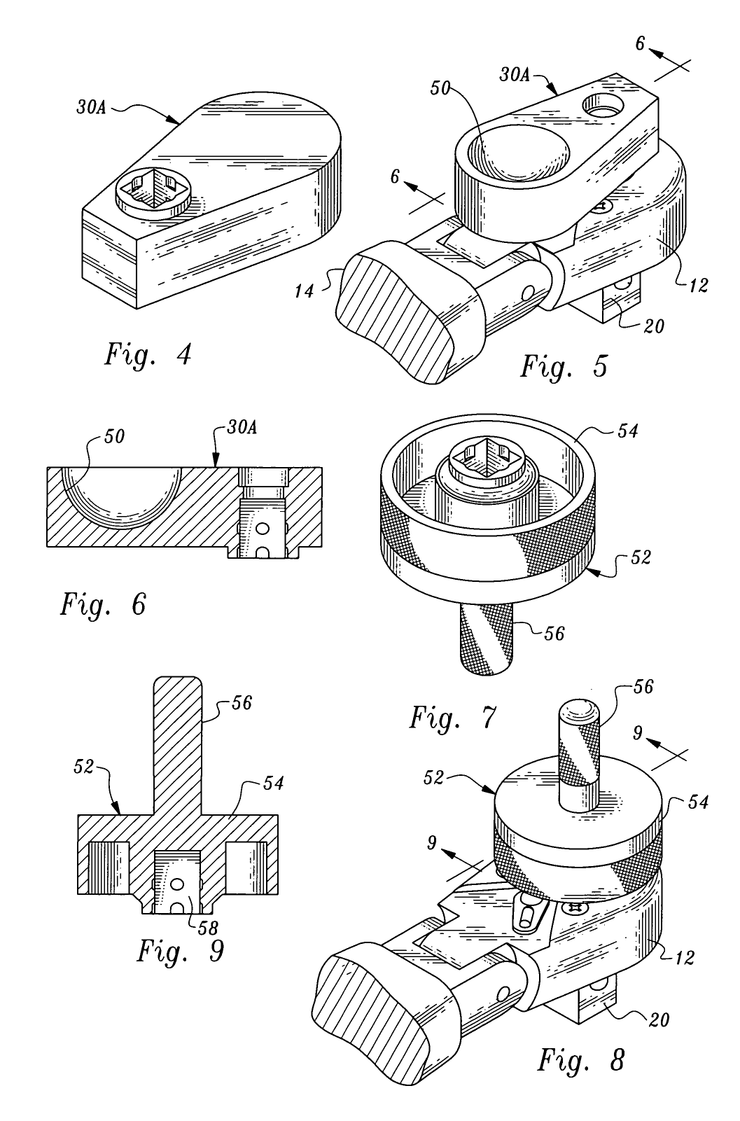

FIGS. 4, 5, 6 and 11 illustrate an alternative embodiment of manually engageable extension member 30A. In this embodiment, the hole for receiving a user's finger is in the form of an indentation 50 defined by the distal end of the manually engageable extension member and receiving an end of a user's finger.

FIGS. 7, 8, 9 and 12 disclose a third embodiment of manually engageable extension member, identified by reference numeral 52. This embodiment is in the form of a knob having two manually engageable knob portions 54, 56. Each of the knob portions has a cylindrically-shaped outer peripheral surface, at least a portion of which is knurled, as shown. The diameter of knob portion 54 is considerably less than that of knob portion 54 and an individual can use either, as appropriate, to turn the manually engageable extension member 52 when attached to a ratchet wrench as shown in FIG. 12. The projection 18 is seated in a recess 58.

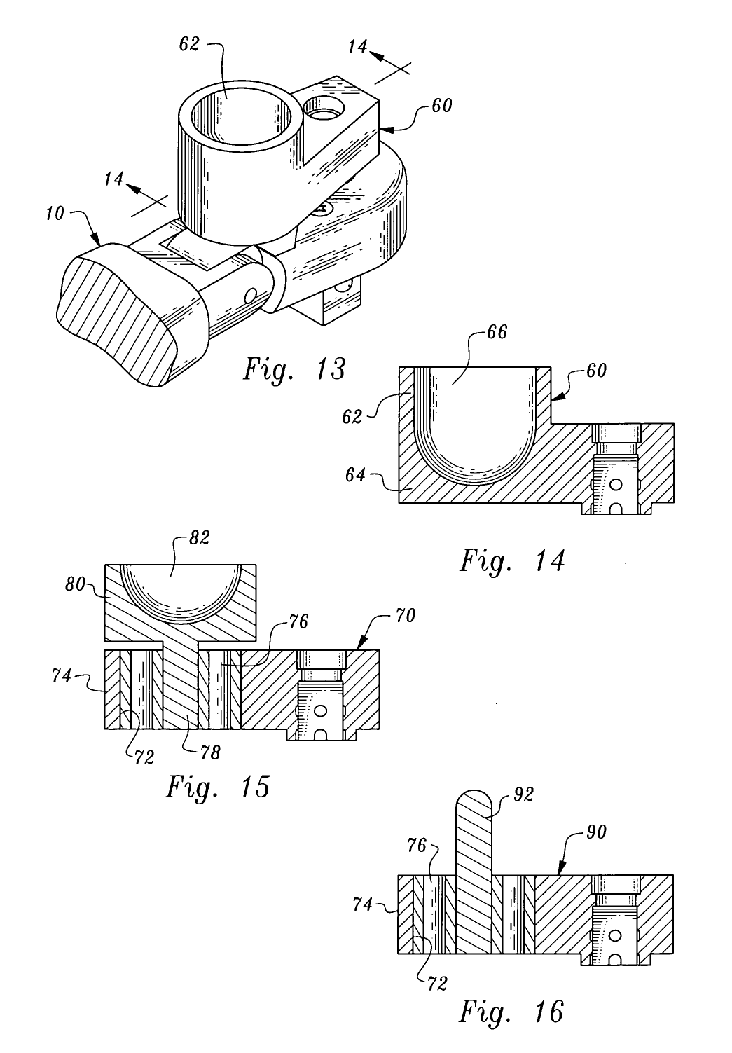

FIGS. 13 and 14 illustrate a fourth embodiment of manually engageable extension member, identified by reference numeral 60. In this embodiment, a cylindrically-shaped wall 62 extends upwardly from the distal end 64 to define a hole in the form of recess 66.

A fifth embodiment of the invention is shown in FIG. 15 and identified by reference numeral 70. In this arrangement a hole in the form of a throughbore 72 is located at distal end 74. A bearing 76 is located in throughbore 72 and a stem 78 of a manually engageable element 80 is rotatably mounted by the bearing. A recess 82 for receiving a user's finger is formed at the outer end of manually engageable element 80. During rotation of the manually engageable extension member by a user, the element 80 will rotate as well, so that the position thereof remains fixed relative to the user's finger.

FIG. 16 illustrates a sixth embodiment 90 similar to the embodiment of FIG. 15. In this instance, however, the manually engageable element comprises a graspable projection 92 extending upwardly from the throughbore 72.

1. In combination:
a hand held ratchet wrench having a wrench head, a wrench handle extending from said ratchet head, a double-sided wrench rotor rotatably mounted in said wrench head, and first and second projections, said projections extending from opposed sides of said double-sided wrench rotor, affixed thereto and rotatable therewith about a common axis of rotation, said first projection being selectively releasably engageable with a socket; and
a manually engageable extension member for connection to the second projection, said manually engageable extension member having a recess for receiving said second projection, said manually engageable extension member when connected to said second projection extending outwardly therefrom and outwardly beyond said wrench rotor for rotating said wrench rotor, said first and second projections and any socket engaged by the first projection, said manually engageable extension member having a surface engaged by an individual at a location spaced from said common axis to impart rotational movement to said first and second projections, said rotor and said socket without rotating said wrench handle.

2. (canceled)

3. The combination according to claim 1 wherein said manually engageable extension member comprises an elongated member having a distal end positioned beyond said wrench head.

4. The combination according to claim 3 wherein said elongated member defines a hole for receiving a finger.

5. The combination according to claim 4 wherein said hole is an opening extending through said distal end.

6. The combination according to claim 4 wherein said hole is an indentation defined by said distal end.

7. The combination according to claim 1 wherein both of said first and second projections are selectively releasably alternatively engageable with a socket and with the manually engageable extension member locked against movement relative to the first and second projections.

8. The connector according to claim 7 wherein said manually engageable extension member includes a base portion defining said recess and an elongated arm attached to said base portion at a location spaced from said wrench head.

9. The combination according to claim 1 wherein said manually engageable extension member comprises a knob having two manually engageable knob portions, each of said knob portions having a cylindrically-shaped outer peripheral surface, the cylindrically-shaped outer peripheral surfaces of said knob portions having different diameters.

10. The combination according to claim 4 wherein said manually engageable extension member additionally comprises a cylindrically-shaped wall extending upwardly from said elongated member at least partially defining said hole.

11. The combination according to claim 3 wherein said elongated member defines a hole at the distal end thereof, said manually engageable extension member additionally comprising a manually engageable element rotatably mounted in said hole.

12. The combination according to claim 11 wherein said manually engageable element defines an indentation for receiving a user's finger.

13. The combination according to claim 11 wherein said manually engageable element comprises a graspable projection extending upwardly from said elongated member.

14. (canceled)

15. (canceled)

16. A manually engageable extension member for releasable connection to a hand held ratchet wrench having a wrench head, a wrench handle extending from said ratchet head, a double-sided wrench rotor rotatably mounted in said wrench head, and first and second projections, said projections extending from opposed sides of said double-sided wrench rotor, affixed thereto and rotatable therewith about a common axis of rotation, said first projection being selectively releasably engageable with a socket, said manually engageable extension member for connection to the second projection, said manually engageable extension member having a recess for receiving said second projection, said manually engageable extension member when connected to said second projection extending outwardly therefrom and outwardly beyond said wrench rotor for rotating said wrench rotor, said first and second projections and any socket engaged by the first projection, said manually engageable extension member having a surface engaged by an individual at a location spaced from said common axis to impart rotational movement to said first and second projections, said rotor and said socket without rotating said wrench handle.

17. In combination:
a hand held ratchet wrench having a wrench head, a wrench handle extending from said ratchet head, a double-sided wrench rotor rotatably mounted in said wrench head, and first and second projections, said projections extending from opposed sides of said double-sided wrench rotor, affixed thereto and rotatable therewith about a common axis of rotation, said first projection being selectively releasably engageable with a socket; and
a manually engageable extension member connected to the second projection and rotatable therewith, said manually engageable extension member extending outwardly from said second projection and outwardly beyond said wrench rotor for rotating said wrench rotor, said first and second projections and any socket engaged by the first projection, said manually engageable member having a surface engaged by an individual at a location spaced from said common axis to impart simultaneous rotational movement to said first and second projections, said rotor and said socket without rotating the wrench handle.
